(19) United States
(12) Patent Application Publication
(10) Pub. No.: US 2015/0201155 A1
(43) Pub. Date: Jul. 16, 2015

(54) ADVERTISEMENT DISTRIBUTION SYSTEM AND METHOD FOR CONTROLLING OPERATIONS OF MOBILE ELECTRONIC DEVICE THEREOF

(71) Applicant: wayStorm Co. Ltd., Taipei City (TW)

(72) Inventors: Ming-Chang Lee, Taipei City (TW); Charng-Da Lu, Taipei City (TW); Yang-Hsin Lin, New Taipei City (TW)

(21) Appl. No.: 14/592,919

(22) Filed: Jan. 9, 2015

(30) Foreign Application Priority Data
Jan. 10, 2014 (TW) 103101065

(51) Int. Cl. H04N 5/93; G06Q 30/02; G11B 27/34; G06K 9/00; G11B 27/28

(52) U.S. Cl. CPC H04N 5/9305; G06K 9/00711; G11B 27/28; G11B 27/34; G06Q 30/0241

(57) ABSTRACT

An advertisement distribution system and a method for controlling operations of a mobile electronic device thereof are provided. The mobile electronic device has a display, a microphone and a display. A media player generates sound by playing a medium which contains an audio watermark, and the microphone converts the sound into an electrical signal. The mobile electronic device decodes the electrical signal to obtain the audio watermark. Based on the obtained audio watermark, the display may display a specific advertisement thereon.

### BACKGROUND OF THE INVENTION

1. Field of the Invention

The present invention is related to an advertisement distribution system and a method for controlling operations of a mobile electric device of the advertisement distribution system, and more particularly to an advertisement distribution system and a method for controlling operations of a mobile electric device of the advertisement distribution system using technologies of audio watermarking.

2. Description of the Prior Art

In recent years, due to the improvements of digital media technologies, transmission, reproduction and modification of digital data are become very easy. Therefore, how to protect intelligent property rights is an important issue. The technologies of audio watermarking enable copyright protection and ownership verification of digital audio data. Audio watermarking is the process of embedding an audio watermark into an original audio signal without influencing the quality of the original audio signal. For an unauthorized user, it is very hard to remove the embedded audio watermark. However, the applications of the technologies of audio watermarking in the prior art are almost limited to the protection of intelligent property rights. Therefore, the technologies of audio watermarking in the prior art are rarely applied to advertisement distribution.

### SUMMARY OF THE INVENTION

An embodiment of the present invention provides a method for controlling operations of a mobile electronic device. The method comprises steps of: converting sound into an electrical signal via a microphone of the mobile electronic device, wherein the sound is generated by a media player by playing a medium which contains an audio watermark; decoding the electrical signal to obtain the audio watermark via a processor of the mobile electronic device; and displaying a specific advertisement on a display of the mobile electronic device according to the obtained audio watermark.

An embodiment of the present invention provides an advertisement distribution system. The advertisement distribution system comprises a plurality of media players, a server and at least a mobile electronic device. The plurality of media players are configured to generate sound by playing media. Each of the media contains an audio watermark. The server comprises a database and a first communication interface. The database is configured to store a plurality of advertisements. The at least a mobile electronic device comprises a display, a microphone, a processor and a second communication interface. The microphone is configured to convert the sound generated by the media players into an electrical signal. The processor is coupled to the display and the microphone, is configured to decode the electrical signal to obtain at least one of the audio watermarks of the media, and generates a feedback signal according to the at least one obtained audio watermark. The second communication interface is coupled to the processor and configured to transmit the feedback signal to the server. The server receives the feedback signal via the first communication interface, and selects a specific advertisement from the advertisements stored in the database according to the feedback signal. The server transmits the specific advertisement to the at least a mobile electronic device via the first communication interface, such that the display of the at least a mobile electronic device displays the specific advertisement.

According to the embodiments of the present invention, the audio watermark embedded in the media would be extracted, and it would be distinguished which medium is played by the media player according to the extracted audio watermark. Accordingly, the server would identify which medium is watched or listened by the user of the mobile electronic device. Therefore, the server may gather statistics of the user's behavior, buying habits, interests, etc. Thus, the server may establish a marketing strategy suitable for the user of the mobile electronic device, and may transmit specific advertisements fitting to the user's behavior, buying habits, interests or other marketing goals to the mobile electronic device. Moreover, by embedding different audio watermarks into different media, the advertisement distribution system may estimate or gather statistics for the total times each medium has been played, such that the advertising benefit of each medium may be estimated objectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an advertisement distribution system according to an embodiment of the present invention.

FIG. 2 is a flow chart of a method for controlling operations of a mobile electronic device according to an embodiment of the present invention.

### DETAILED DESCRIPTION

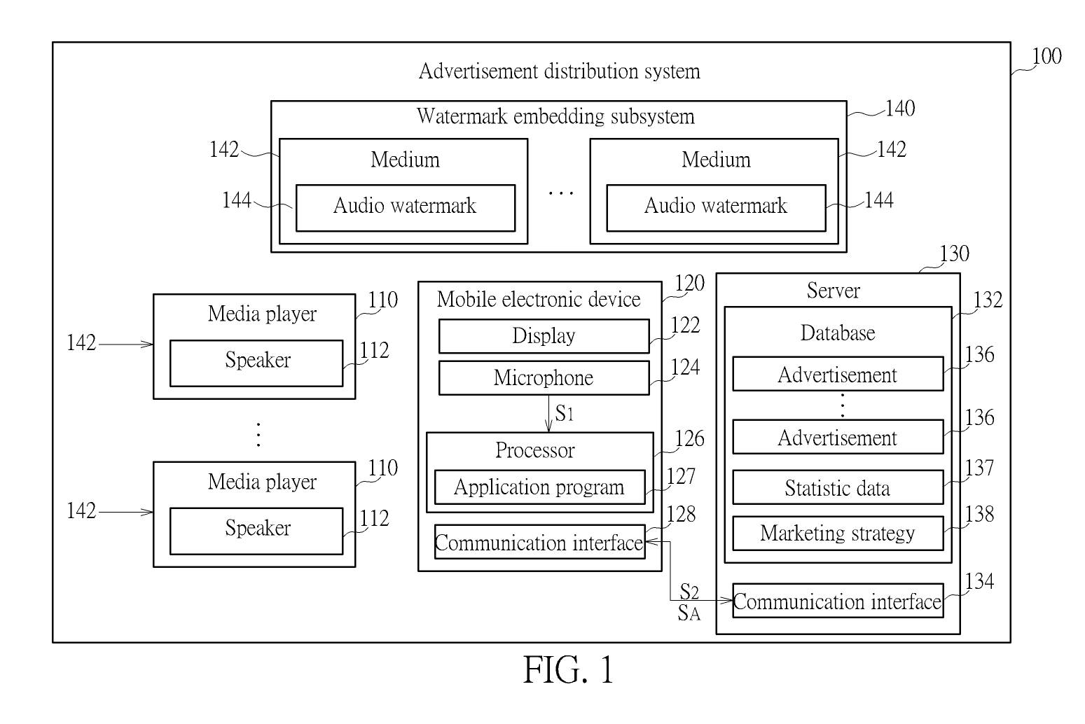

Please refer to FIG. 1. FIG. 1 is a functional block diagram of an advertisement distribution system 100 according to an embodiment of the present invention. The advertisement distribution system 100 comprises a plurality of media players 110, a server 130 and at least a mobile electronic device 120. The plurality of media players 120 are configured to generate sound by playing media 142. The media 142 may include but be not limited to television programs, radio broadcasting programs, Internet video streaming programs (e.g. programs on YouTube®), laser videodisks (e.g. blue-ray disks, Digital Video Disks (DVDs) or Video Compact Discs (VCDs)), games, multi-media programs, movies, digital video files (e.g. MPEG2, MP4 files), digital audio files (e.g. MP3 files), etc. Moreover, the media players 110 may include but be not limited to televisions, radios, personal computers, mobile phones, tablet PCs, consoles, multi-media players, etc. Each of the media players 110 has a speaker 112 configured to generate sound (i.e. sonic waves) according to the media 142. Each of the media 142 (i.e. a medium 142) contains an audio watermark 144. Different media 142 may contain different audio watermarks 144.

The server 130 comprises a database 132 and a communication interface 134. The database 130 is configured to store a plurality of advertisements 136. The mobile electronic device 120 may be but not limited to a mobile phone, a tablet PC, a notebook, a digital video recorder, a digital camera or other electronic device. The mobile electronic device 120 comprises a display 122, a microphone 124, a processor 126 and a communication interface 128. The microphone 124 is configured to convert the sound generated by the media players 110 by playing the media 142 into an electrical signal S₁. The processor 126 is coupled to the display 122, the microphone 124 and the communication interface 128. The processor 126 is configured to decode the electrical signal S₁ to obtain at least one of the audio watermarks 144 of the media 142, and the processor 126 generates a feedback signal S₂ according to the obtained audio watermark 144. Additionally, the space between the microphone 124 of the mobile electronic device 120 and the speaker 112 of each media player 110 for transmitting sonic waves may be termed an acoustic channel. The microphone 124 receives the audio watermarks 144 hidden in the sound from different media player 110 via different acoustic channels. Moreover, the communication interface 128 may be a wireless communication interface configured to transmit the feedback signal S₂ to the server 130. The format of the feedback signal S₂ may be the format of extensible markup language (XML) or JavaScript Object Notation (JSON), and the communication interface 128 may transmit the feedback signal S₂ to the server 130 according to Hypertext Transfer Protocol (http), Hypertext Transfer Protocol Secure (https) or other protocol established based on Transmission Control Protocol/Internet Protocol (TCP/IP). The server 130 receives the feedback signal S₂ from the communication interface 128 via the communication interface 134, and the server 130 selects a specific advertisement S_{A} from the advertisements 136 stored in the database 132 according to the feedback signal S₂. Afterward, the server 130 transmits the specific advertisement S_{A} to the mobile electronic device 120 via the first communication interface 134, such that the display 122 of the mobile electronic device 120 displays the specific advertisement S_{A}. The specific advertisement S_{A} may include but not limited to a coupon, sales promotion, brand information, information of surrounding stores or so on.

In an embodiment of the present invention, the advertisement distribution system 100 may further comprises a watermark embedding subsystem 140 which is configured to embed the audio watermarks 144 in the media 142. The watermark embedding subsystem 140 may embed the distinguishable audio watermarks 144 in the media 142 according to the property or marketing goal of each of the media 142. For example, different audio watermarks 144 may be embedded into the same medium 142 which will be played in different branches of a company, such that different branches of the company may use different marketing strategies for their own customers. Moreover, the media players 110 may be set on different places, and different audio watermarks 144 may be embedded into the same medium 142 which will be played by the media players 110 set on different places. Accordingly, the audio watermarks 144 extracted by the mobile electronic devices 120 may be served as reference for distinguishing the locations of the mobile electronic devices 120, and the server 130 may analyze and gather statistics for the advertising benefit of each media player 110. Furthermore, the server 130 may determine the content of the specific advertisement S_{A} according to the location of the mobile electronic device 120, such that the content of the specific advertisement S_{A} may be suitable for specific customers. In addition, it should be understood that the watermark embedding subsystem 140 may operate independently from the server 130 or be integrated in the server 130.

In an embodiment of the present invention, the server 130 generates statistic data 137 according to the feedback signal S₂. Moreover, the server 130 establishes a marketing strategy 138 for the mobile electronic device 120 according to the statistic data 137, and the server 130 determines a succeeding advertisement 136 that will be transmitted to the mobile electronic device 110 according to the marketing strategy 138. In detail, the mobile electronic devices 120 generates the feedback signal S₂ according to the extracted audio watermark 144, such that the server 130 may identify which medium 142 is played by the mobile electronic device 110 according to the feedback signal S₂. Therefore, the server 130 may identify which medium 142 is watched or listened by the user of the mobile electronic device 120, and the server 130 may analyze and gather statistics for the user's behavior, buying habits, interests, etc. Thus, the server 130 may establish the marketing strategy 138 suitable for the user of the mobile electronic device 120, and may transmit the specific advertisement S_{A} fitting to the user's behavior, buying habits, interests or other marketing goals to the mobile electronic device 120. Furthermore, the server 130 may estimate or gather statistics for the length and total times each medium 142 has been played according to different statistic data 137 that are generated for different mobile electronic devices 120, such that the advertising benefit of each medium 142 is objectively estimated, and that the length and total times each medium 142 has been played may be the basis and the standard for charging for placing the advertisement 136.

In the above embodiments, the mobile electronic device 120 receives the specific advertisement S_{A} from the server 130 and displays the specific advertisement S_{A} on the display 122. In an embodiment of the present invention, the specific advertisement S_{A} may be directly embedded in the audio watermark 144, and the processor 126 directly extracts the specific advertisement S_{A} from the audio watermark 144 to control the display 122 to display the extracted specific advertisement S_{A}. In another embodiment of the present invention, the plurality of advertisements 136 may be set in an application program 127. When the processor 126 obtains the audio watermark 144, the processor 126 selects the specific advertisement S_{A} from the advertisements 136 set in the application program 127 according to the audio watermark 144 and controls the display 122 to display the selected specific advertisement S_{A}.

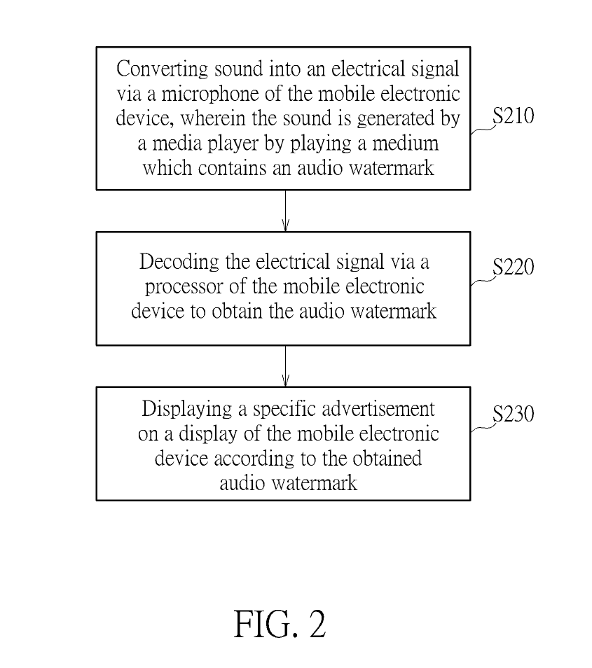

Please refer to FIG. 2. FIG. 2 is a flow chart of a method for controlling operations of a mobile electronic device according to an embodiment of the present invention. The method comprises following steps:

Step S210: converting sound into an electrical signal via a microphone of the mobile electronic device, wherein the sound is generated by a media player by playing a medium which contains an audio watermark;

Step S220: decoding the electrical signal via a processor of the mobile electronic device to obtain the audio watermark; and

Step S230: displaying a specific advertisement on a display of the mobile electronic device according to the obtained audio watermark.

In summary, according to the embodiments of the present invention, the audio watermark embedded in the media would be extracted, and it would be distinguished which medium is played by the media player according to the extracted audio watermark. Accordingly, the server would identify which medium is watched or listened by the user of the mobile electronic device. Therefore, the server may gather statistics of the user's behavior, buying habits, interests, etc. Thus, the server may establish a marketing strategy suitable for the user of the mobile electronic device, and may transmit specific advertisements fitting to the user's behavior, buying habits, interests or other marketing goals to the mobile electronic device. Moreover, by embedding different audio watermarks into different media, the advertisement distribution system may estimate or gather statistics for the length and total times each medium has been played, such that the advertising benefit of each medium may be estimated objectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling operations of a mobile electronic device, the method comprising:
a microphone of the mobile electronic device converting sound into an electrical signal, wherein the sound is generated by a media player by playing a medium which contains an audio watermark;
a processor of the mobile electronic device decoding the electrical signal to obtain the audio watermark; and
displaying a specific advertisement on a display of the mobile electronic device according to the obtained audio watermark.

2. The method of claim 1 further comprising:
the mobile electronic device transmitting a feedback signal to a server according to the audio watermark; and
the server generating statistic data according to the feedback signal.

3. The method of claim 2 further comprising:
the server establishing a marketing strategy for the mobile electronic device according to the statistic data; and
the server determining a succeeding advertisement that will be transmitted to the mobile electronic device according to the marketing strategy.

4. The method of claim 1, wherein displaying a specific advertisement on a display of the mobile electronic device according to the obtained audio watermark comprises:
the mobile electronic device transmitting a feedback signal to a server according to the audio watermark; and
the server selecting the specific advertisement from a plurality of advertisements according to the feedback signal and transmitting the specific advertisement to the mobile electronic device.

5. The method of claim 1 further comprising:
determining a location of the mobile electronic device according to the audio watermark; and
determining content of the specific advertisement according to the location of the mobile electronic device.

6. An advertisement distribution system, comprising:
a plurality of media players, configured to generate sound by playing media, wherein each of the media contains an audio watermark;
a server, comprising
a database, configured to store a plurality of advertisements; and
a first communication interface; and
at least a mobile electronic device, comprising:
a display;
a microphone, configured to convert the sound generated by the media players into an electrical signal;
a processor, coupled to the display and the microphone, and configured to decode the electrical signal to obtain at least one of the audio watermarks of the media and generate a feedback signal according to the at least one obtained audio watermark; and
a second communication interface, coupled to the processor and configured to transmit the feedback signal to the server;
wherein the server receives the feedback signal via the first communication interface, and selects a specific advertisement from the advertisements stored in the database according to the feedback signal;
wherein the server transmits the specific advertisement to the at least a mobile electronic device via the first communication interface, such that the display of the at least a mobile electronic device displays the specific advertisement.

7. The advertisement distribution system of claim 6, wherein the server determines which one of the media is played according to the feedback signal.

8. The advertisement distribution system of claim 6, wherein the server generates statistic data according to the feedback signal, establishes a marketing strategy for the mobile electronic device according to the statistic data, and determines a succeeding advertisement that will be transmitted to the mobile electronic device according to the marketing strategy.

9. The advertisement distribution system of claim 6 further comprising a watermark embedding subsystem which is configured to embed the audio watermarks in the media.
